(19) United States
(12) Patent Application Publication
(10) Pub. No.: US 2009/0010145 A1
(43) Pub. Date: Jan. 8, 2009

(54) OPTICAL RECORD CARRIER

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,700

(22) PCT Filed: Sep. 26, 2005
(86) PCT No.: PCT/IB05/53178

§ 371 Date: Apr. 5, 2007

(30) Foreign Application Priority Data
Oct. 8, 2004 (EP) 04104922.2
Jan. 12, 2005 (EP) 05100149.3

(51) Int. Cl. G11B 7/24

(52) U.S. Cl. 369/275.3

(57) ABSTRACT

The present invention relates to an optical record carrier. The optical record carrier has a plurality of tracks disposed substantially spirally and substantially concentrically, each track being adapted for recording and/or reproducing optically readable effects positioned substantially in a groove. In a first aspect, the plurality of tracks are arranged adjacently in a multi-track spiral on the optical record carrier, and a tracking area between the windings of the multi-track spiral is adapted for providing a radial tracking error signal from the optical record carrier. In a second aspect, the plurality of spirals are arranged in concentric consecutive layers similar to an opinion structure on the optical record carrier with one spiral in each layer, and tracking areas between the said layers of the plurality of spirals are adapted for providing a radial tracking error signal from the optical record carrier. The invention also relates to a corresponding optical apparatus and a method for manufacturing a carrier according to the second aspect.

The present invention relates to an optical record carrier comprising a substrate and a plurality of tracks disposed substantially spirally and substantially concentrically on the carrier. The invention also relates to a method for manufacturing such a carrier.

The invention further relates to a corresponding optical apparatus adapted for reproducing and/or recording information from/to an optical record carrier according to the invention. In order to meet the demand of increasing information storage capacity the available optical media, i.e. compact disc (CD), digital versatile disc (DVD) and the Blu-ray Disc (BD), show a constant improvement in storage capacity. In these optical media, the reproduction resolution has hitherto been mostly dominated by the wavelength, λ, of the reproduction light and the numerical aperture (NA) of the optical reproduction apparatus. However, since it is not easy to shorten the wavelength of the reproduction light or to increase the numerical aperture of the corresponding lens system, attempts to increase the recording density has pre-dominantly been focused at improving the recording media and/or the recording/reproduction method.

In particular, for optical media adapted for recording information two different approaches have been suggested: The land-groove format wherein information is recorded both in the groove of the track and next to the groove, and the groove-only format wherein the information is only recorded in the groove, e.g. the BD disc format. Both of these formats have advantages and disadvantages, in particular with respect to radial tracking and inter-track/symbol cross-write/erase issues.

Presently, the density limit reached by combining a track pitch of 240 nm with a channel bit length of 50 nm has shown that the capacity of the BD-type disc can potentially be increased from the current 23-25-27 GB up to 50 GB per layer of information on the media. However, an inherent conflict between further downscaling of the track pitch versus the need for stabile radial tracking and limited cross-write/erase problems is encountered in present state of the art discs. In particular, a disc format with both the advantages of the land-groove format with respect to stable radial tracking and the advantages of the groove-only format with respect to limited cross-write/erase problems is therefore desirable.

Hence, an improved optical record carrier would be advantageous, and in particular a more efficient and/or reliable optical record carrier would be advantageous.

Accordingly, the invention preferably seeks to mitigate, alleviate or eliminate one or more of the above-mentioned disadvantages singly or in any combination. In particular, it may be seen as an object of the present invention to provide an optical record carrier that solves the above mentioned problems of the prior art with obtaining an increased information storage density on the optical record carrier.

This object and several other objects are obtained in a first aspect of the invention by providing an optical record carrier comprising a substrate, a plurality of tracks disposed substantially spirally and substantially concentrically, each track being adapted for recording and/or reproducing optically readable effects positioned substantially in a groove, wherein the plurality of tracks are arranged adjacently in a multi-track spiral on the optical record carrier, and wherein a tracking area between the windings of the multi-track spiral is adapted for providing a radial tracking error signal from the optical record carrier.

The invention according to the first aspect is particularly but not exclusively advantageous for obtaining a lower track pitch, i.e. track width, of the tracks in the spiral due to the tracking area positioned between the windings of the multi-track spiral. In addition, the possibility of a lowered track pitch does not jeopardize the radial tracking as the radial tracking is to be performed in the dedicated tracking area also known as guard band. The commonly used single spiral format has an inherent conflict between the radial tracking provided by the groove and the wish to minimize the track pitch, a conflict that is solved by the present invention. The optical record carrier, and in particular the track and groove format, according to the present invention thereby provides several advantages for obtaining more efficient and reliable optical record carrier.

In a second aspect, the invention relates to an optical record carrier that comprises a substrate, a plurality of tracks disposed substantially spirally and substantially concentrically, each track being adapted for recording and/or reproducing optically readable effects positioned substantially in a groove, wherein the plurality of spirals are arranged in concentric consecutive layers on the optical record carrier with one spiral in each layer, and wherein tracking areas between the said layers of the plurality of spirals are adapted for providing a radial tracking error signal from the optical record carrier.

The invention according to the second aspect is particularly but not exclusively advantageous for obtaining a lower track pitch of the tracks in the spirals due to the tracking areas positioned between the consecutive spirals. Moreover, the possibility of a lowered track pitch does not jeopardize the radial tracking as the radial tracking is to be performed in the dedicated tracking areas also known as guard bands. It is a particular advantage of the invention according to the second aspect that the media manufacturing may be performed on manufacturing equipment adapted for producing media with a single spiral as the guard bands can be made by just skipping mastering a groove at regular intervals. Thus, already present manufacturing equipment may relatively simple be adapted to produce the optical record carrier according to the second aspect of the invention.

The tracking areas or the guard bands have a certain width. The width of the guard band should be chosen such that proper radial tracking signals are ensured. This means in practice that the guard band should be around 280-300 nm (or wider) for the case of BD optics. In this case the well-known push-pull signal, as used for radial tracking on the empty discs in all the current write-once and rewritable systems, can be generated robustly. The push-pull signal is advantageous because the effective track spacing as seen by the optical spot placed on the guard band is much larger (locally under the spot) than the actual track spacing within the tracks in the multi-spiral according to the first aspect of the invention or within the tracks of a single spiral according to the second aspect of the invention. The optical record carrier according to the first or the second aspect may have at least one of the one or more guard bands or tracking area(s) having a width that is at least equal to a track width of a track positioned adjacently to the tracking area. The said lower limit may also be set as two, three or fours times an adjacent track width. Advantageous lower limits on the width of the tracking area(s) are approximate values of: 50, 100, 150, 200, 250, 300, 350, and 400 nm.

The width of the tracking area(s) may also be limited from above in order to minimize the carrier area used for radial tracking. Thus, the optical record carrier may have at least one of the one or more tracking area(s) of a width that is maximum equal to four times the track width of a track positioned adjacently to the tracking area, alternatively two, three, five or six times an adjacent track width. Advantageous upper limits on the width of the tracking area(s) are approximate values of: 200, 250, 300, 350, 400, 450, and 500 nm.

The track width or track pitch may also calculated as an average value of the nearest neighboring tracks, i.e. up till two, three, four or more tracks next to the tracking area(s).

The optical record carrier according to the first or the second aspect of the invention is particularly advantageous in that there is at least one of the one or more trucking area(s) that does not comprise a groove or any other pre-embossed marks like pre-pits or similar intended and/or adapted for radial tracking. This makes the manufacturing of a carrier according to the present invention easier to manufacture relative to prior art carriers with dedicated tracking pits in guard bands, see for example US 2004/0076110. In the context of the present application, by “tracking area” is meant a continuous area having substantially uniform optical properties in the radial servo frequency band such that a reliable radial tracking error signal can be generated there for controlling the tracking closed loop. This servo-frequency requirement allows writing DC-free data in the guard band. In many write-once and rewritable disc formats known at present (like CD-R/RW, DVD±R/RW or BD-R/RE), a wobble is embedded in the grooves for carrying the timing and/or the address information. The channel bit size at a certain position on the disc is directly related to the wobble period at that position. The optical record carrier according to the first and second aspect of the invention may similarly have wobbling grooves, i.e. a groove with a physical parameter varying in a longitudinal direction of the groove, said variation being indicative of timing and/or address information related to said groove on the optical record carrier.

In particular, the varying physical parameter of a first groove within a spiral varies substantially in phase with the same physical parameter of a second groove within the same spiral; thus the first and second groove may be synchronous wobbling. This is advantageous to minimize the effective track pitch if the first and second grooves are adjacent on the carrier. Even with some out-of-phase deviation it would still provide advantages; e.g. up till a quarter of a period phase difference may be acceptable.

The varying physical parameter of a first groove within a spiral may vary, at least locally, with an substantially constant angular frequency (CAF) relative to a central position of the optical record carrier. In this case, the inter-groove spacing is constant (which is nice from the cross-write performance point of view), but the linear wobble frequency decreases towards the outer radius of the disc. In order to obtain sufficiently uniform storage density across the carrier and to maintain simultaneously the constant ratio between the wobble and the data frequencies, zoned or locally CAF wobble can be used. However, this solution is somewhat cumbersome from the carrier mastering and the drive implementation points of view.

Alternatively, the optical record carrier may have the varying physical parameter of a first groove within a spiral to vary, at least locally, with a substantially constant frequency in the longitudinal direction of the first groove. This is known as a constant linear frequency (CLF) wobbling. This ensures an equal tangential storage density across the whole disc and it is normally used in case of the regular single-spiral systems like CD, DVD and BD. However, the inter-groove spacing (land width) is not constant in this case. This should be taken into account when targeting very small track pitches, since the cross-write performance can be compromised at the positions where the grooves come too close with respect to each other. This makes the CLF format less suitable for the case of very small track pitches. However, if the CLF format is applied locally the storage density may be kept substantially constant in this locally constant linear frequency format (LCLF).

Recently, the advent of Two Dimensional Optical Storage (TwoDOS) has been demonstrated. In TwoDOS, information is written as a number of data rows in parallel along a broad spiral on and carrier, and the data is read-out in parallel from the spiral using an array of laser spots. The TwoDOS system is particularly well adapted for applying an optical record carrier according to the first of aspect of the present invention as the optical record carrier may adapted for having the optical readable effects of a plurality of tracks within said spiral being simultaneously reproduced. This is so because the TwoDOS-like systems with joint multi-row detection become advantageous with respect to the one-dimensional ones in terms of cross-talk performance only when the track pitch is very small, typically in the order of 220 nm for the case of BD optics, and such a low track pitch may be obtainable with the present invention.

If the first aspect of the present invention is applied in connection with a TwoDOS-like system, the plurality of tracks may each have at least a portion of a groove having a physical parameter varying in a longitudinal direction of the groove, e.g. wobbling of the groove, said variation being indicative of timing and/or address information related to said groove on the optical record carrier, and wherein the said variation provides information related to synchronizing the said simultaneous reproduction as synchronizing is an important parameter to control for a TwoDOS-like system. In particular, the information provided for synchronizing may be the channel bit clock.

For an optical record carrier according to the second aspect of the invention, the plurality of spirals may have a starting point for each track and an end point for each track, and each end point of a track may be positioned with a relative angular separation in relation to the start point of the adjacent consecutive spiral, the relative angular separation between adjacently positioned spirals may be, at least locally, substantially constant on the optical record carrier. Thus, a constant angular frequency (CAF) shift may be implemented between the consecutive spirals. This is advantageous in order to perform radial tracking “jumps”, i.e. changes between spirals, at a substantially constant carrier rotation speed at a specific time of operation. The angular separation between the different “rounds” of the spirals may be substantially constant, possibly just a local level, e.g. when averaged over a portion of the carrier by e.g. introducing a number of carrier zones in which the rounds are substantially constant. The number of zones may vary from 2 to, say, 10.000.

For an optical record carrier according to the second aspect of the invention, the plurality of spirals may have a starting point for each track and an end point for each track, and each end point of a track may be positioned with a tangential linear separation in relation to the start point of the adjacent consecutive spiral, the tangential linear separation between adjacently positioned spirals being, at least locally, substantially constant on the optical record carrier. Such a constant linear frequency (CLF) shift is advantageous as the radial tracking “jumps”, i.e. changes between spirals, may be performed at a substantially constant linear carrier speed at a specific time of operation.

An optical record carrier according to the first or the second aspect of the invention may additionally be further adapted for recording and/or reproducing optically readable effects substantially outside a groove so as to increase the storage density of the carrier. This is similar to the land-groove format applied in the DVD-RAM format. Additionally or alternatively, the optical record carrier may be further adapted for recording and/or reproducing optically readable effects in a tracking area under due consideration of the cross-write effects. Normally, the presence of data is not disturbing the radial tracking. Hence, data or information in the form of optically readable effects may be recorded outside the grooves because the influence of data outside the grooves on the tracking signals does not dependent on data density but rather on the average reflectivity level of the written track. Hence, there is effectively no limit with respect to the data density in connection with tracking. However, the data density in the guard bands may be limited by the laser power used for writing the data, as the power should avoid too much thermal influence on the adjacent tracks e.g. data marks there may not be erased or otherwise damaged. Earlier it was stated that the tracking area(s) has substantially uniform optical properties, at least locally, but any data in the tracking area(s) may be considered an exception to such a uniformity. This is so because DC-free data in the guard band may then allowed since they are invisible in the servo frequency band if the DC-notch of the data is made sufficiently wide.

In a third aspect, the invention also relates to method for manufacturing an optical record carrier comprising the steps of providing a substrate, providing in or on said substrate a plurality of tracks disposed substantially spirally and substantially concentrically, each track being adapted for recording and/or reproducing optically readable effects positioned substantially in a groove, wherein the plurality of spirals are arranged in concentric consecutive layers on the optical record carrier with one spiral in each layer, and wherein tracking areas between the said layers of the plurality of spirals are adapted for providing a radial tracking error signal from the optical record carrier.

The invention according to the third aspect is particularly but not exclusively advantageous for obtaining a method that may easily be implemented by applying already known manufacturing equipment for conventional single-spiral groove format carriers. In a particular embodiment, the tracking areas between the said layers of the plurality of spirals is obtained by simply not mastering one or more tracks, i.e. during the manufacturing of the optical record carrier the track mastering equipment simply “jumps” one or more grooves, preferably just one groove.

In a fourth aspect, the invention relates to an optical apparatus adapted for reproducing and/or recording information from/to an optical record carrier according to the first or the second aspect of the invention, the optical apparatus comprising holding means to fixate and rotate the optical record carrier, a light source capable of emitting a light beam for reading information as readable effects and/or recording information as readable effects, photodetection means capable of detecting reflected light from the optical record carrier and transform it into electrical signals, and processing means adapted to process said electric signals and generate control signals in response thereto for controlling the holding means and the light source, by at least one control mechanism, said at least one control mechanism comprising at least a radial tracking error control mechanism adapted for performing radial tracking on a carrier according to the first or the second aspect of the invention.

The invention according to the fourth aspect is particularly but not exclusively advantageous for obtaining an optical apparatus that may reproduce and/or record information from/to an optical record carrier according to the first or the second aspect of the invention. In particular, some standard optical drives may only require relatively few modifications, especially with respect to the radial tracking, to be able to reproduce/record from/to optical record carrier according to the first or the second aspect. Accordingly, the optical apparatus according to the fourth aspect of the invention is readily implemented.

The first, second, third and fourth aspect of the present invention may each be combined with any of the other aspects.

These and other aspects of the invention will be apparent from and elucidated with reference to the embodiments described hereinafter. The present invention will now be explained with reference to the accompanying Figs., where

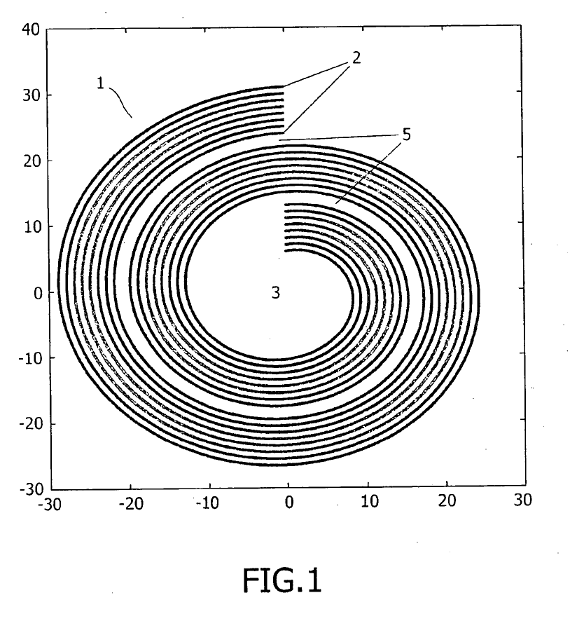

FIG. 1 is a schematic drawing of the carrier format according to the first aspect of the invention.

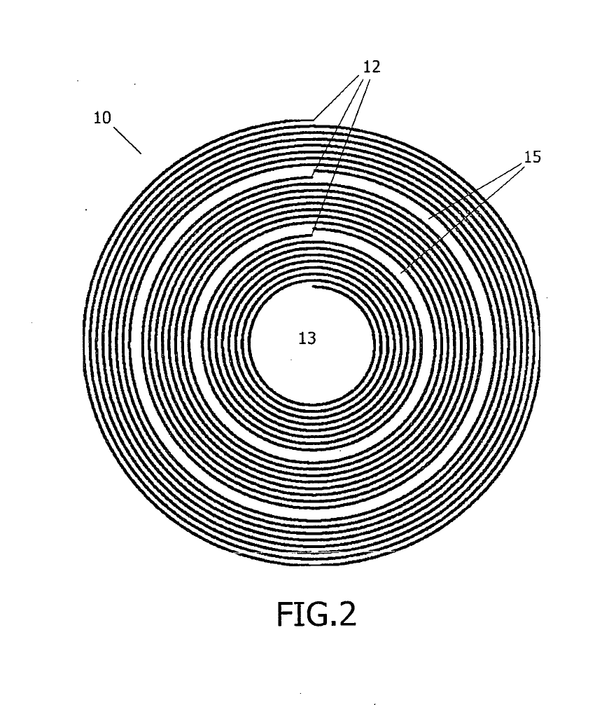

FIG. 2 is a schematic drawing of the carrier format according to the second aspect of the invention,

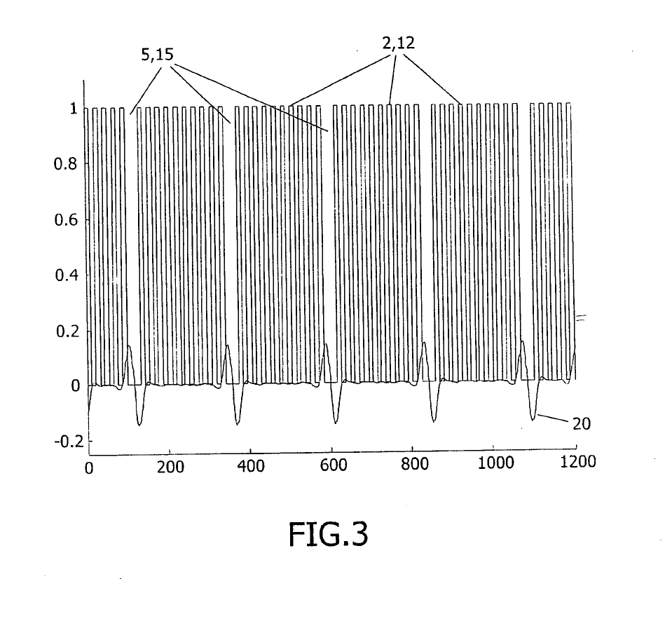

FIG. 3 shows a vertical-radial cross-section of a carrier superimposed with a corresponding radial tracking error signal,

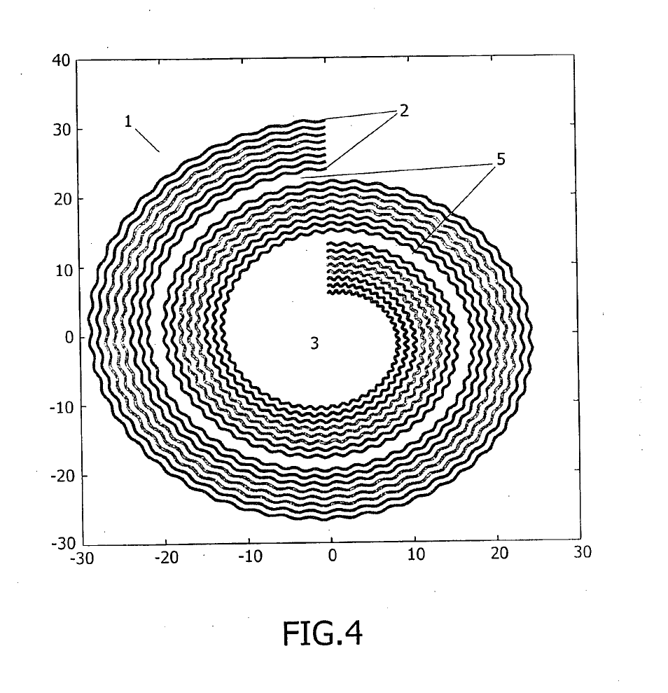

FIG. 4 shows a schematic drawing of an embodiment of the carrier format according to first aspect of the invention having a constant angular frequency (CAF),

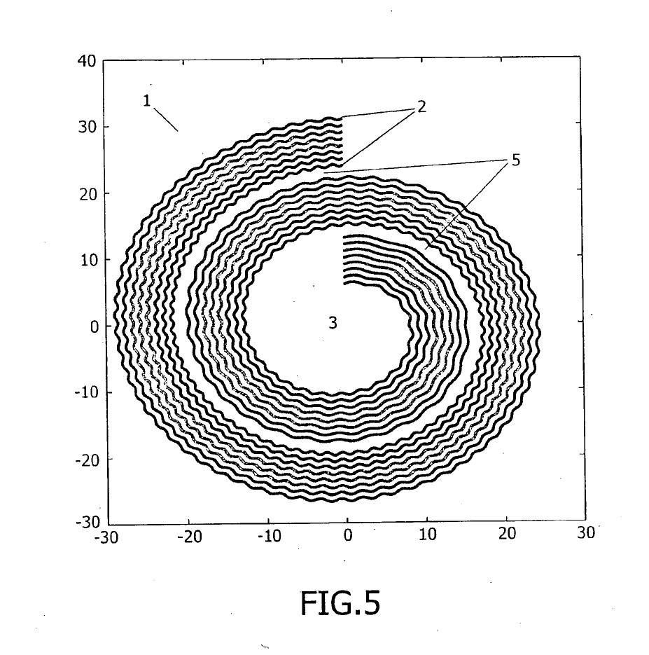

FIG. 5 shows a schematic drawing of an embodiment of the carrier format according to first aspect of the invention having a constant linear frequency (CLF),

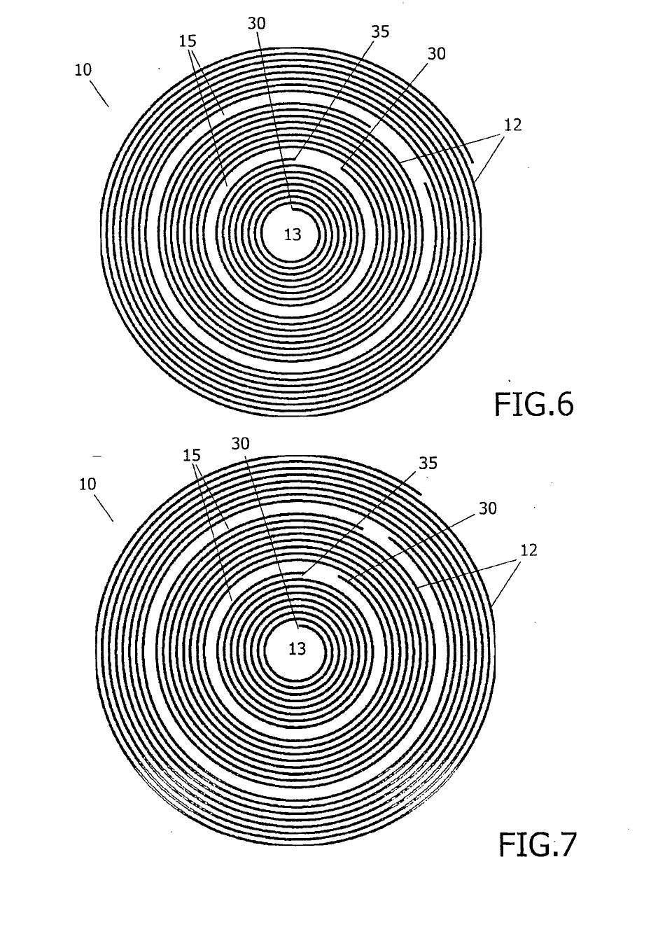

FIG. 6 shows a schematic drawing of an embodiment of the carrier format according to second aspect of the invention having a constant angular velocity (CAV) shifted edges,

FIG. 7 shows a schematic drawing of an embodiment of the carrier format according to second aspect of the invention having a constant linear velocity (CLV) shifted edges,

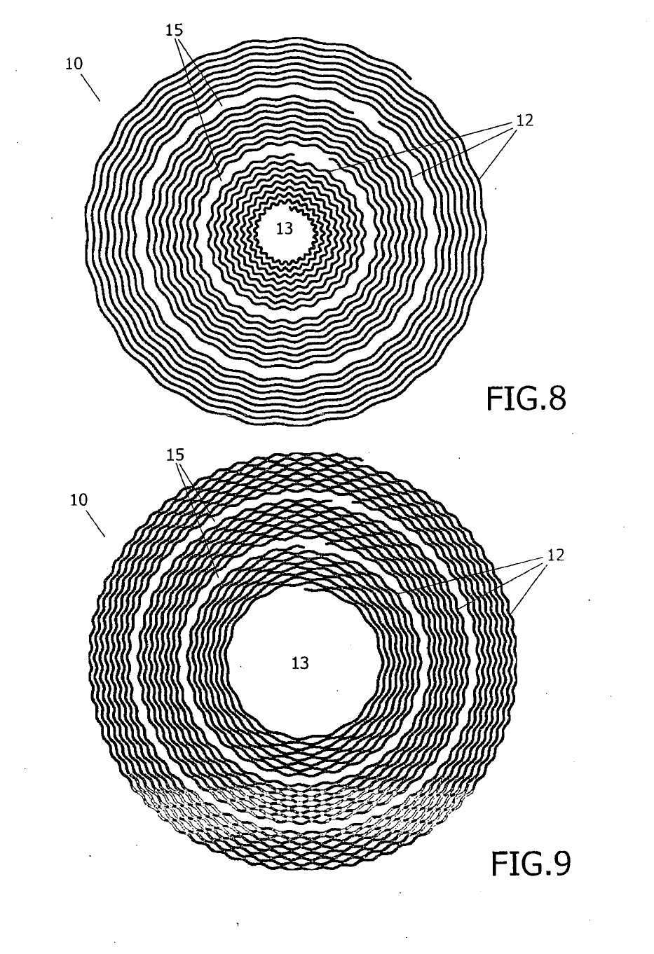

FIG. 8 shows a schematic drawing of an embodiment of the carrier format according to second aspect of the invention having a constant angular frequency (CAF) wobbling address format,

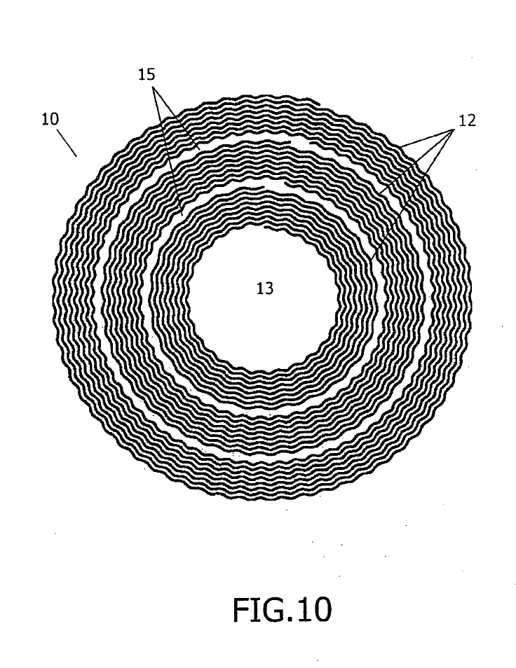

FIG. 9 shows a schematic drawing of an embodiment of the carrier format according to second aspect of the invention having a constant linear frequency (CLF) wobbling address format, and

FIG. 10 shows a schematic drawing of an embodiment of the carrier format according to second aspect of the invention having a constant locally linear frequency (LCLF) wobbling address format.

FIG. 1 is a schematic drawing of the carrier format according to the first aspect of the invention. A plurality of tracks 2 are disposed substantially spirally and substantially concentrically with respect to central position 3 on the carrier. Each track 2 is adapted for recording and/or reproducing optically readable effects positioned substantially in a groove (not shown). The optically readable effects may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier.

The plurality of tracks 2 are arranged adjacently in a multi-track spiral 1 on the optical record carrier and the number of tracks in FIG. 1 is eight. The number of tracks 2 in the broad spiral 1 is determined by a compromise between the radial servo system complexity and the storage capacity decrease due to the fact that the guard band 5 contains no data or possibly that the data density in the guard band 5 is lower than in the grooves of the broad spiral. It is expected that the multi-spiral 1 with eight tracks is the most practical one; although the broad spirals 1 with somewhat smaller or somewhat larger number tracks are also feasible. Thus, the number of tracks 2 may also be: 4, 6, 10, 12, 14, 16, 18, and 20.

The tracking area 5 between the windings of the multi-track spiral 1 is adapted for providing a radial tracking error signal from the optical record carrier. Several methods are available for obtaining the error in a radial direction, i.e. the deviation from the actual radial position relative to the intended or ideal radial position, one such method being the push-pull (PP) method where a tracking error signal is generated on the basis of the level difference between optical signals detected in an optical sensor of an optical reproducing apparatus. Another option is the differential time (or phase) detection (DTD) method, where a phase difference between the optical signals detected in the optical sensors of the optical reproducing apparatus is applied for generating a radial tracking error signal. State-of-the-art differential PP methods apply the 3-spot method where a main light beam follows the track of information and two auxiliary light beams are shifted in opposite directions relative to the track, but any suitable method for performing radial tracking so as to keep the focused light on the intended radial position on the carrier by a closed loop control mechanism may be adapted within the context of the present invention.

FIG. 2 is a schematic drawing of the carrier format 10 according to the second aspect of the invention. A plurality of tracks 12 are disposed substantially spirally and substantially concentrically with respect to a central position 13 on the carrier. Each track 12 is adapted for recording and/or reproducing optically readable effects positioned substantially in a groove (not shown). The plurality of spirals 10 are arranged in concentric consecutive layers 12 on the optical record carrier with one spiral in each layer similar to the structure of an onion. In FIG. 2, just three consecutive spirals 12 are shown for clarity but for an actual carrier the number of spirals 12 or “onion-shelves” may vary between 2 and 1.000.000. The tracking areas 15 between the spirals 12 are adapted for providing a radial tracking error signal from the optical record carrier as will be further explained in FIG. 3.

FIG. 3 shows a vertical-radial cross-section of carrier superimposed with the corresponding radial tracking error signal 20 obtained by the one spot push-pull radial tracking error method. The scales of the plot are arbitrary. FIG. 3 illustrates how a tracking signal is obtained from a carrier according to both the first and the second aspect of the present invention. In FIG. 3, the radial position on the carrier is plotted on the horizontal scale. On the vertical scale, the push-pull radial tracking signal 20 is plotted which corresponds to the optical spot being scanned along the radial direction. The physical structure of the grooves is also indicated on the vertical scale. The amplitude of 1 corresponds to bottom of the grooves, whereas the carrier surface is positioned at an amplitude of 0. Thus, as seen there are no grooves in the tracking area(s) 5 and 15.

The grooves are grouped in either a multi-spiral 1 with tracks 2 or consecutive spirals 12 in the carrier format 10 according to the aspect of the invention. Both are 10-track-wide, and the inter-spiral separation, i.e. the tracking area(s) or guard band 5 or 15, is achieved by not mastering every 11-th groove. Since the optical spot resolution is finite leading essentially to a low-pass characteristic of the channel response, the very high frequency of tracks within the broad groups 2 or 12 is not getting captured. In the given embodiment the following data applies: numerical aperture (NA)=0.85, wave length of light=405 nm and track pitch of 220 nm with a duty circle of 50%.

As it is visible in FIG. 3, there is an almost-zero push-pull signal 20 not suitable for tracking within the tracks 2 of the multi-spiral 1 or within the consecutive spirals 12. At the guard bands, however, the groove structure has a significant lower frequency component due to the larger track spacing there, and the push-pull tracking signal 20 is strong and provides a clear “S-curve” around the middle of the guard band 5 and 15. This means that the optical spot can reliably track the middle of the guard band 5 and 15 from the obtained radial tracking signal but the individual tracks 2 of multi-spiral 1 or the consecutive spirals 12 does not give rise to a useful radial tracking error signal. In the given example, the guard band width is 3×120 nm=360 nm, while the push-pull signal 20 vanishes only at the spatial track spacing below 240 nm for the given characteristics of the optical spot. That means that the guard band 5 and 15 can also be made narrower, down to approximately 280 nm.

In the following Figs., particular embodiments of the first and second aspect will be explained. FIGS. 4 and 5 show embodiments of the first aspect, whereas FIGS. 6 to 10 show embodiments of the second aspect.

FIG. 4 shows a schematic drawing of an embodiment of the carrier format 1 according to first aspect of the invention having a constant angular frequency (CAF) of wobbling. Thus, the tracks 2 of the carrier wobbles around their longitudinal direction with a constant angular separation relative to a central position 3 on the carrier. The wobble is embedded in the grooves for carrying the timing and/or the address information. As it is evident from the FIG. 4, the constant angular frequency causes the linear wobbling frequency to decrease towards an outer radius of the carrier.

FIG. 5 shows a schematic drawing of an embodiment of the carrier format 1 according to first aspect of the invention having a constant linear frequency (CLF) of wobbling. Thus, the tracks 2 of the carrier wobbles around their longitudinal direction with a constant linear separation. As it is evident from the FIG. 5, the constant linear frequency results in a varying angular wobbling frequency, i.e. the angular wobbling frequency with respect to a central position 3 on the carrier increases towards an outer radius of the carrier.

FIGS. 6 and 7 are embodiments where the tracks 12 are not wobbling. The embodiments illustrate various radial tracking “jumps” between the consecutive spirals 12. The start/stop positions 30 and 35, respectively, of the consecutive spirals 12 can be located either at the same angular position, as in FIG. 2, or at different angular positions as depicted in FIGS. 6 and 7. The additional space created between the stop-position 35 of the inner spiral 12 and the start-position 30 of the next outer consecutive spiral 12 can be advantageously used for performing the radial tracking servo jump from the inner “round” to the next outer one since this type of jumps is needed for the most used streaming (linear) access to the carrier. Otherwise, carrier access time is increased since an additional carrier revolution is needed to get to the start-position of the next outer “round” 12.

FIG. 6 shows a schematic drawing of an embodiment of the carrier format 10 according to second aspect of the invention having a constant angular velocity (CAV) shifted edges. This embodiment is particular advantageous for a carrier operated in a constant angular velocity (CAV) mode. The spirals 12 has a starting point 30 for each track and an end point 35 for each track, and each end point 35 of a track is positioned with a relative angular separation in relation to the start point 30 of the adjacent consecutive spiral 12. The relative angular separation between adjacently positioned spirals 12 is substantially constant on the optical record carrier as measured from a central position on the carrier 13. As a further variation it may also be applied only locally, e.g. the relative angular separation is constant within a limited number of spirals 12 on the carrier, such as for 2 up to 10.000. In the above description of FIG. 6, it is assumed that the starting points 30 and the end points 35 are named relative to an observer starting from an inner position on the carrier, but an outer position on the carrier may of course equivalently be applied causing the starting points 30 and the end points 35 to be named oppositely.

FIG. 7 shows a schematic drawing of an embodiment of the carrier format 10 according to second aspect of the invention having a constant linear velocity (CLV) shifted edges. This embodiment is particular advantageous for a carrier operated in a constant linear velocity (CLV) mode. The starting point 30 for each track 12 and an end point 35 for each track, and each end point 35 of a track is positioned with a tangential linear separation in relation to the start point 30 of the adjacent consecutive spiral 12. The tangential linear separation between adjacently positioned spirals 12 is substantially constant on the optical record carrier. It may alternatively be applied only locally, e.g. the tangential linear separation is constant within a limited number of spirals 12 on the carrier, such as for 2 up to 10.000. In the above description of FIG. 7, it is assumed that the starting points 30 and the end points 35 are named relative to an observer starting from an inner position on the carrier, but an outer position on the carrier may of course equivalently be applied causing the starting points 30 and the end points 35 to be named oppositely.

FIG. 8 shows a schematic drawing of an embodiment of the carrier format 10 according to second aspect of the invention having a constant-angular frequency (CAF) wobbling address format. Thus, the tracks 12 of the carrier wobbles around their longitudinal direction with a constant angular separation relative to a central position 13 on the carrier. The wobble is embedded in the grooves for carrying the timing and/or the address information. As it is evident from the FIG. 8, the constant angular frequency causes the linear wobbling frequency to decrease towards an outer radius of the carrier.

FIG. 9 shows a schematic drawing of an embodiment of the carrier format 10 according to second aspect of the invention having a constant linear frequency (CLF) wobbling address format. The tracks 12 of the carrier wobbles around their longitudinal direction with a constant linear separation. As it is evident from the FIG. 9, the constant linear frequency results in a varying angular wobbling frequency, i.e. angular wobbling frequency increases towards an outer radius of the carrier. The CLF format may alternatively be applied only locally. This will be illustrated in FIG. 10 below.

FIG. 10 shows a schematic drawing of an embodiment of the carrier format 10 according to second aspect of the invention having a constant locally linear frequency (LCLF) wobbling address format. Thus, the tracks 12 of the carrier wobbles around their longitudinal direction with a constant linear separation but only at a local level, i.e. within a number of adjacent broad spirals 12: say, from 2 till 10.000. The advantage of this embodiment is the possibility to keep the storage density substantially constant across the carrier 1. Additionally, the possibility of having tracks 12 that wobbles synchronously provides the possibility of lowering the effective track pitch.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical record carrier comprising:
a substrate,
a plurality of tracks (2) disposed substantially spirally and substantially concentrically,
each track (2) being adapted for recording and/or reproducing optically readable effects positioned substantially in a groove,
wherein the plurality of tracks (2) are arranged adjacently in a multi-track spiral (1) on the optical record carrier, and
wherein a tracking area (5) between windings of the multi-track spiral (1) is adapted for providing a radial tracking error signal from the optical record carrier.

2. An optical record carrier comprising:
a substrate,
a plurality of tracks (12) disposed substantially spirally and substantially concentrically to form a plurality of spirals (10),
each track (12) being adapted for recording and/or reproducing optically readable effects positioned substantially in a groove,
wherein the plurality of spirals (10) are arranged in concentric consecutive layers (12) on the optical record carrier with one spiral in each layer, and
wherein tracking areas (15) between, the said layers of the plurality of spirals (10) are adapted for providing a radial tracking error signal from the optical record carrier.

3. An optical record carrier according to claim 1 or 2, wherein at least one of the one or more tracking area(s) (5, 15) has a width that is at least equal to a track width of a track (2, 12) positioned adjacently to the tracking area (5, 15).

4. An optical record carrier according to claim 1 or 2, wherein at least one of the one or more tracking area(s) (5, 15) has a width that is maximum equal to four times the track width of a track (2, 12) positioned adjacently to the tracking area (5, 15).

5. An optical record carrier according to claim 1 or 2, wherein at least one of the one or more tracking area(s) (5, 15) does not comprise a groove.

6. An optical record carrier according to claim 1 or 2, wherein each groove has at least a portion with a physical parameter varying in a longitudinal direction of the groove, said variation being indicative of timing and/or address information related to said groove on the optical record carrier.

7. An optical record carrier according to claim 6, wherein the varying physical parameter of a first groove within a spiral varies substantially in phase with a same physical parameter of a second groove within the same spiral.

8. An optical record carrier according to claim 6, wherein the varying physical parameter of a first groove within a spiral varies, at least locally, with a substantially constant angular frequency relative to a central position (3, 13) of the optical record carrier.

9. An optical record carrier according to claim 6, wherein the varying physical parameter of a first groove within a spiral varies, at least locally, with a substantially constant frequency in the longitudinal direction of the first groove.

10. An optical record carrier according to claim 1, wherein the optical record carrier is adapted for having the optical readable effects of a plurality of tracks (2) within said spiral being simultaneously reproduced.

11. An optical record carrier according to claim 10, wherein the plurality of tracks (2) each has at least a portion of a groove having a physical parameter varying in a longitudinal direction of the groove, said variation being indicative of timing and/or address information related to said groove on the optical record carrier, and wherein the said variation provides information related to synchronizing the said simultaneous reproduction.

12. An optical record carrier according to claim 2, wherein the plurality of spirals has a starting point (30) for each track (12) and an end point (35) for each track (12), and wherein each end point of a track is positioned with a relative angular separation in relation to the start point of the adjacent consecutive spiral (12), the relative angular separation between adjacently positioned spirals (12) being, at least locally, substantially constant on the optical record carrier.

13. An optical record carrier according to claim 2, wherein the plurality of spirals has a starting point (30) for each track (12) and an end point (35) for each track (12), and wherein each end point of a track is positioned with a tangential linear separation in relation to the start point of the adjacent consecutive spiral (12), the tangential linear separation between adjacently positioned spirals (12) being, at least locally, substantially constant on the optical record carrier.

14. An optical record carrier according to claim 1 or 2, wherein the optical record carrier is further adapted for recording and/or reproducing optically readable effects substantially outside a groove.

15. An optical record carrier according to claim 14, wherein the optical record carrier is adapted for recording and/or reproducing optically readable effects in a tracking area (5, 15).

16. A method for manufacturing an optical record carrier comprising the steps of:
providing a substrate,
providing in or on said substrate a plurality of tracks (12) disposed substantially spirally and substantially concentrically to form a plurality of spirals (10), each track (12) being adapted for recording and/or reproducing optically readable effects positioned substantially in a groove,
wherein the plurality of spirals (10) are arranged in concentric consecutive layers (12) on the optical record carrier with one spiral in each layer, and
wherein tracking areas (15) between the said layers of the plurality of spirals (10) are adapted for providing a radial tracking error signal from the optical record carrier.

17. An optical apparatus adapted for reproducing and/or recording information from or to an optical record carrier according to claim 1 or claim 2, the optical apparatus comprising:
holding means to fixate and rotate the optical record carrier,
a light source capable of emitting a light beam for reading information as readable effects and/or recording information as readable effects,
photodetection means capable of detecting reflected light from the optical record carrier and transforming said reflected light into electrical signals, and
processing means adapted to process said electrical signals and generate control signals in response thereto for controlling the holding means and the light source, by at least one control mechanism, said at least one control mechanism comprising at least a radial tracking error control mechanism adapted for performing radial tracking on said carrier.
